(19) United States
(12) Patent Application Publication
(10) Pub. No.: US 2006/0227974 A1
(43) Pub. Date: Oct. 12, 2006

(54) Encryption and decryption method

(76) Inventor: Attila Haraszti, Budapest (HU)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/093,781

(22) Filed: Mar. 30, 2005

(51) Int. Cl. H04L 9/00

(52) U.S. Cl. 380/280

(57) ABSTRACT

For the purpose of data encryption a reference data vector is acquired from a reference object. The reference object can be a physical object such as a passport, a biometric feature, or a rendered data object. A set of random vectors for each bit to be encoded is determined on the basis of the reference data vector. For the purpose of decryption the reference data vector is acquired again.

### TECHNICAL FIELD

The present invention relates to the field of cryptography.

### BACKGROUND

In traditional cryptography, the sender and receiver of a message know and use the same secret key: the sender uses the secret key to encrypt the message, and the receiver uses the same secret key to decrypt the message. This method is known as secret-key or symmetric cryptography.

The main challenge is getting the sender and receiver to agree on the secret key without anyone else finding out. If they are in separate physical locations, they must trust a courier, a phone system, or some other transmission medium to prevent the disclosure of the secret key. Anyone who overhears or intercepts the key in transit can later read, modify, and forge all messages encrypted or authenticated using that key. The generation, transmission and storage of keys is called key management; all cryptosystems must deal with key management issues. Because all keys in a secret-key cryptosystem must remain secret, secret-key cryptography often has difficulty providing secure key management, especially in open systems with a large number of users.

Data Encryption Standard (DES) is a widely used method of data encryption using a private (secret) key. For each given message, the key is chosen at random from a very large number of possible keys. Like other private key cryptographic methods, both the sender and the receiver must know and use the same private key.

DES applies a 56-bit key to each 64-bit block of data. The process can run in several modes and involves 16 rounds or operations. Although this is considered “strong” encryption, many companies use “triple DES”, which applies three keys in succession. DES is specified in the ANSI X3.92 and X3.106 standards and in the Federal FIPS 46 and 81 standards.

In order to solve the key management problem, Whitfield Diffie and Martin Hellman introduced the concept of public-key cryptography in 1976. Public-key cryptosystems have two primary uses, encryption and digital signatures. In their system, each person gets a pair of keys, one called the public key and the other called the private key. The public key is published, while the private key is kept secret.

The need for the sender and receiver to share secret information is eliminated; all communications involve only public keys, and no private key is ever transmitted or shared. In this system, it is no longer necessary to trust the security of some means of communications. The only requirement is that public keys be associated with their users in a trusted (authenticated) manner (for instance, in a trusted directory). Anyone can send a confidential message by just using public information, but the message can only be decrypted with a private key, which is in the sole possession of the intended recipient. Furthermore, public-key cryptography can be used not only for privacy (encryption), but also for authentication (digital signatures) and various other techniques.

In a public-key cryptosystem, the private key is always linked mathematically to the public key. Therefore, it is always possible to attack a public-key system by deriving the private key from the public key. Typically, the defence against this is to make the problem of deriving the private key from the public key as difficult as possible. For instance, some public-key cryptosystem are designed such that deriving the private key from the public key requires the attacker to factor a large number, it this case it is computationally infeasible to perform the derivation. This is the idea behind the RSA public-key cryptosystem.

The invention facilitates provision of an improved solution for the key management problem.

### BRIEF DESCRIPTION OF THE DRAWINGS

In the following, preferred embodiments of the invention will be described, by way of example only, and with reference to the drawings, in which:

FIG. 1 is a flow chart showing a method for encrypting of binary data;

FIG. 2 illustrates the result of the encoding method of FIG. 1;

FIG. 3 is a flow chart showing a method for decrypting data that is encrypted in accordance with the encryption method shown in FIG. 1;

FIG. 4 is a block diagram of a computer system for encrypting, transmitting and decrypting data;

FIG. 5 is a flow chart showing a method for encrypting of data by means of a pseudo random number generator;

FIG. 6 is a flow chart illustrating the decryption method corresponding to the encryption method of FIG. 5;

FIG. 7 is a block diagram of a computer system that implements the encryption and decryption methods of FIGS. 5 and 6;

FIG. 8 is illustrative of a grid that is used for filtering an image;

FIG. 9 is illustrative of the result of the filtering operation;

FIG. 10 is a flow chart showing a method for producing a passport with encrypted data;

FIG. 11 is a flow chart showing a method for authentication of the passport;

FIG. 12 is a flow chart showing a method for digitally signing a document;

FIG. 13 is a flow chart showing a method for checking the authenticity of the digitally signed document; and

FIG. 14 is a block diagram of a computer system that implements the methods of FIGS. 12 and 13.

### DETAILED DESCRIPTION

In one aspect the invention provides a method of encrypting binary data. A reference data vector is acquired using a reference object. For encoding of each bit of the binary data a random vector is determined on the basis of the reference data vector.

This encryption method is particularly advantageous as the key management problem is avoided. In contrast to the prior art encryption is not performed on the basis of an exact key but on the basis of a reference object from which a reference data vector is acquired.

In accordance with an embodiment, the reference object is a physical object. In this case some kind of measurement is performed on the physical object in order to acquire the reference data vector that is the basis for determining the random vectors for encoding of the data.

In accordance with an embodiment, a biometric object is used as a reference object, such as a user's fingerprint, iris, voice, or face. Biometric features are extracted from the biometric reference object in order to acquire the reference data vector.

In accordance with a further embodiment, an image is used as a reference object. For example, a photograph of a passport or chip card can be used as such an image. The image is scanned and filtered in order to obtain the reference data vector. Preferably the filtering involves some kind of averaging in order to increase the robustness of the method.

In accordance with a further embodiment, a data object is used as a reference object. For acquisition of the reference data vector the data object is rendered by means of a rendering program, such as a text processing program where the data object is a text document, and the data acquisition is performed on the rendered data object.

In accordance with a further embodiment, the random vector for encoding one of the bits is determined by generating a candidate random vector and by calculating the scalar product of the candidate random vector and the reference data vector. In case the absolute value of the scalar product is (i) above a pre-defined threshold value and (ii) the sign of the scalar product corresponds to the bit to be encoded, the candidate random vector is accepted for encoding of the bit and stored. In case the candidate random vector does not fulfil these two requirements (i) and (ii) another candidate random vector is generated and the conditions are tested again. This procedure continues until a candidate random vector is identified that fulfils both conditions.

In accordance with a further embodiment, a running index of the accepted candidate random vector is stored rather than the complete candidate random vector. The combination of the running index and the seed value of the pseudo random number generator that is used for generating of the random vectors unequivocally identifies the complete random vector. This way the size of the result of the encryption can be reduced drastically.

In accordance with a further embodiment, a data file is encrypted. For example a user can encrypt a data file on his or her computer on the basis of one of his or her biometric features in order to protect the data file against unauthorised access.

In accordance with a further embodiment, a user's personal data, such as the user's name as printed on his or her passport or chip card, is encrypted. This is useful for checking the authenticity of the passport or chip card.

In accordance with a further embodiment, a symmetric key is encrypted on the basis of the reference object. For example, the symmetric key is used for encryption of a large data file. The symmetric key itself is encrypted in accordance with a method of the present invention on the basis of a reference object. This way the symmetric key is protected in a secure way while avoiding the disadvantages of prior art key management approaches.

Another embodiment provides a method of decrypting binary data. The binary data comprises a random vector for each encoded bit. The decoding is performed by acquiring a reference data vector from a reference object. The decryption of one of the bits is performed on the basis of one of the random vectors and the reference data vector.

In accordance with another embodiment of the invention the decryption of one of the bits is performed by determining the sign of the scalar product of the reference data vector and the one of the random vectors.

Decryption of the encrypted binary data is only possible if the reference object is authentic. Depending on the implementation, decrypting requires the encryptor's biometric data, the image that was used as a reference object for the encryption, e.g. the user's passport, or rending of a data object that was used for acquisition of the reference data for the encryption. It is to be noted that the reference data vector that was used for the encryption does not need to be reproduced in an exact way for the decryption; some degree of error in the acquisition of the reference data vector is allowed without negatively affecting the decryption.

Embodiments may be particularly advantageous in that it facilitates solution of the prior art key management problem in a user friendly, convenient and yet secure way. The embodiments can be used in various fields for the purposes of protecting the confidentiality of data and for the purpose of authentication of documents or files.

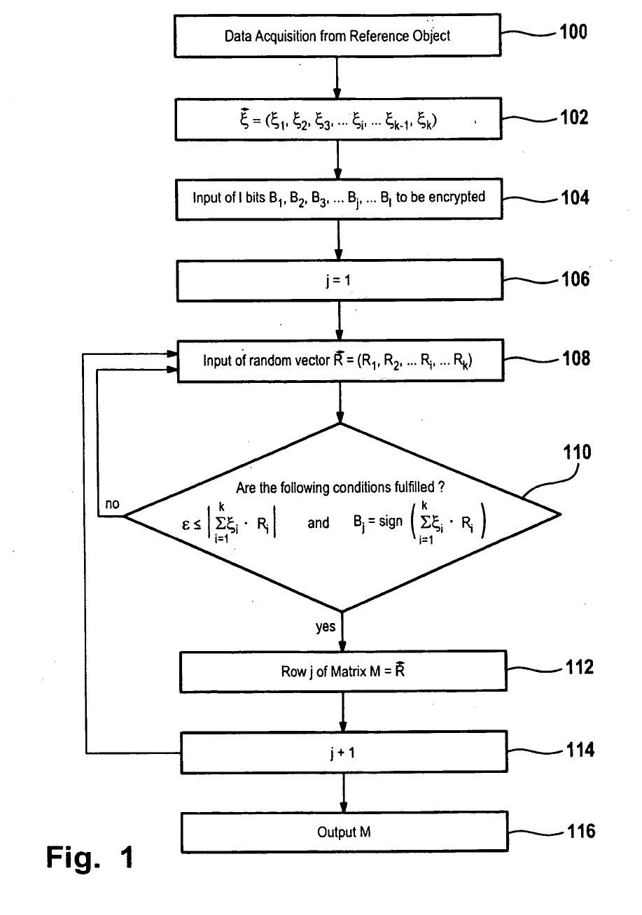

FIG. 1 shows a flow chart for encryption of 1 bits of binary data B1 B2, B3, . . . Bj, . . . Bl . A reference object is used as a basis of the encryption. As a matter of principle any physical or data object that has a certain uniqueness can be used as such a reference object. For example, an image, such as a photo printed or attached to a document, can be used as a reference object. Alternatively a rendered data file is used as a reference object, such as a text file that is rendered by a text processing program. As a further alternative a portion of a person's body is used as a reference object for extraction of biometric features, or a user's utterance, such as the user's voice.

Depending on the kind of reference object a data acquisition step is performed (step 100). This way the reference data vector \vec{ξ} is obtained (step 102) that has a number k of values obtained from the reference data object.

Preferably there is some kind of filtering of the raw data acquired from the reference object in order to provide the reference data vector \vec{ξ}. For example, the raw data is filtered by a low pass filter for increased robustness of the encoding and decoding method.

Further, it is useful to normalize the data vector \vec{ξ}. This way all values ξᵢ are within a defined range, such as between [−1; 1].

In step 104 the 1 bits to be encrypted are entered. In step 106 the index j is initialised. In step 108 a first candidate random vector \vec{R} is generated by means of a random number generator. The random vector \vec{R} has the same size k as the reference data vector \vec{ξ}.

In step 110 the scalar product of the reference data vector and the candidate random vector is calculated. If the absolute value of this scalar product is above a predefined threshold level ε a first condition is fulfilled. If the sign of the scalar product matches the bit Bj to be encoded this means that the candidate random vector can be accepted for encoding of bit Bj.

For example, if the bit Bj is ‘0’ the sign of the scalar product needs to be ‘−’ and if Bj=1 then the sign of the scalar product needs to be ‘+’.

In other words the candidate random vector \vec{R} is accepted for encrypting bit Bj if both of the following conditions are met:

$$\begin{matrix}ɛ \leq \vert {\sum }_{i = 1}^{k} {ξ}_{i} \cdot {R}_{i} \vert and & ( i ) \\ {B}_{j} = sign ( {\sum }_{i = 1}^{k} {ξ}_{i} \cdot {R}_{i} ) & ( ii )\end{matrix}$$

If one of the conditions (i) and (ii) is not fulfilled the control goes back to step 108 for generation of a new candidate random vector which is then tested against the two conditions (i) and (ii) in step 110. Steps 108 and 110 are carried out repeatedly until a candidate random vector has been found that fulfils both of the conditions of step 110. The accepted candidate random vector constitutes row j of matrix M (step 112). In step 114 index j is implemented and the control goes back to step 108 for encoding of the next bit Bj of the 1 bits to be encrypted.

After encryption of all 1 bits the control goes to step 116 where the matrix M is outputted as a result of the encryption.

It is to be noted that the choice of threshold ε is a trade off between security and processing time. The security of the encoding is proportional to the value of the threshold ε. However, increasing ε also increases the average number of attempts for finding an acceptable candidate random vector. A convenient choice for ε is 1, 2, 3, 4, 5, or 6, preferably between 3 and 4, most probably ε=3.7.

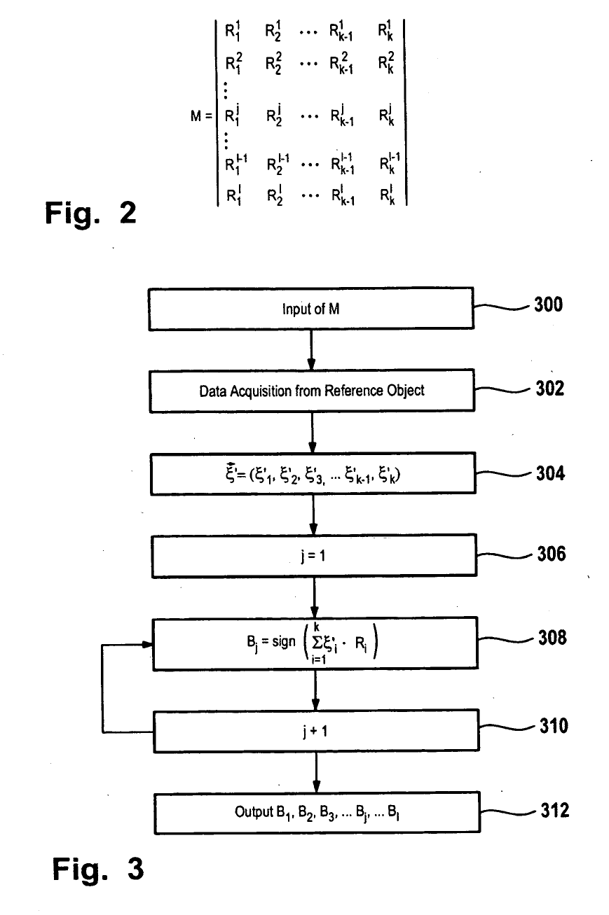

FIG. 2 shows the resulting matrix M that has a number 1 of rows and k of columns. Each row j of matrix M is assigned to one of the bits Bj and contains the random vector that encodes the respective bit Bj.

Decryption of matrix M in order to recover the encrypted bits is only possible if the decryptor is in the possession of the reference object that was used for the encryption (cf. step 100 of FIG. 1) as the reference data vector \vec{ξ} is not stored in the matrix M or elsewhere.

FIG. 3 illustrates a corresponding decryption method. In step 300 the matrix M is entered. In step 302 data is acquired from the reference object. On this basis the reference data vector is \vec{ξ}′ obtained (step 304). It is to be noted that the data acquisition step 100 of FIG. 1 and data acquisition step 302 of FIG. 3 are substantially identical. However, in case the reference object is a physical object the data acquisition will involve some kind of measurement error.

As a consequence the raw data obtained from the measurements of the reference object will not be exactly the same in step 100 of FIG. 1 and step 302 of FIG. 3. As a consequence reference data vector \vec{ξ}′ provided in step 304 will also not be identical to reference data vector \vec{ξ} provided in step 102 in FIG. 1. Despite such differences between the reference data vector \vec{ξ} that was used for the encoding and the reference data vectors \vec{ξ}′ that forms the basis of the decoding, a correct decoding of the matrix M can be performed in order to obtain the ‘hidden’ bits B1 . . . Bj

In step 306 the index j is initialised. In step 308 the scalar product of the reference data vector and the random vector \vec{ξ}′ in row j of matrix M that is assigned to bit Bj is calculated. The sign of the scalar provides the decoded bit value Bj whereby the same convention as for the encoding is used. In other words, when the sign is negative, the bit value is ‘0’; if the sign is positive the bit value Bj is ‘1’.

In step 310 the index j is implemented and the control goes back to step 308 for decoding of the next bit position. Steps 308 and 310 are carried out repeatedly until all 1 bit positions have been decoded. The decoded 1 bits are outputted in step 312.

It is to be noted that the encryption and decryption methods of FIGS. 1 and 3 are particularly advantageous as they are error tolerant in view of unavoidable measurement errors in the data acquisition from the reference object. Typically the reference data vectors used for the encryption and for the decryption will not be exactly the same but still a correct decryption result is obtained with a high degree of reliability and security.

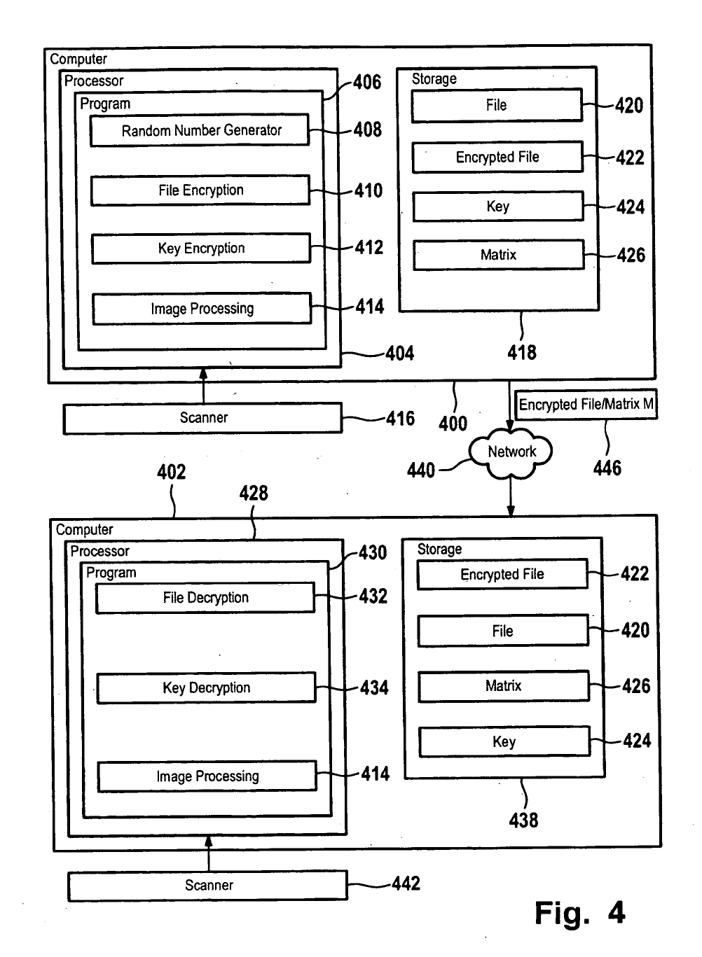

FIG. 4 shows a block diagram of a corresponding computer system. The computer system has computer 400 that is used for encryption and computer 402 that is used for decryption. Computer 400 has processor 404 for running program 406. Program 406 has program modules 408, 410, 412 and 414. Program module 408 implements a random number generator. Program module 410 serves for encryption of a file by means of a symmetric key, such as by DES encryption. Program module 412 serves for encryption of the symmetric key in accordance with the method of FIG. 1. Program module 414 serves for image processing of image data provided by scanner 416 that is coupled to computer 400.

Computer 400 has storage 418 for storage of file 420, encrypted file 422, symmetric key 424 and matrix 426 that results from the encoding of symmetric key 424.

Computer 402 has processor 428 for running of program 430. Program 430 has program modules 432, 434, 414.

Computer 402 has storage 438. Storage 438 serves for storage of the encrypted file 422 received via network 440 from computer 400. Further, storage 438 serves for storage of the decrypted file 420, matrix 426 received via network 440 from computer 400 and the decrypted symmetric key 424.

Scanner 442, that is similar to scanner 416, is coupled to computer 402.

In operation, computer 400 is used for encryption of file 420. File 420 is encrypted by means of program module 410 using symmetric key 424. The resulting encrypted file 422 is stored in storage 418. For encryption of symmetric key 424 the user scans a reference object, such as his or hers passport, by means of scanner 416.

The resulting raw image data is processed by program module 414. For example program module 414 performs some kind of low pass filtering and normalization of the raw image data obtained from scanner 416. The filtered image data is provided to program module 412 that performs the encryption of symmetric key 424 in accordance with the method of FIG. 1 using program module 408 as a source for the candidate random vectors. The resulting matrix M 426 is stored in storage 418.

For decryption of encrypted file 422 computer 402 receives data object 446 containing encrypted file 422 and matrix 426. In order to initiate the decryption the user has to scan in the reference object, e.g. his or hers passport. This will result in similar raw image data as obtained in the original scan for the encryption. The raw image data are processed in the same way as for the encryption by program module 414 of program 430.

The filtered image data is provided to program module 434 that performs the decryption of matrix M 426 in accordance with the method of FIG. 3. The result of the decryption performed by program module 434 is symmetric key 424 that is stored in storage 438. By means of symmetric key 424 program module 432 decrypts encrypted file 422 which provides the original file 420.

It is to be noted that the computer system of FIG. 4 does not require a key management system for the symmetric key 424. Rather a convenient reference object, such as the user's passport or other unique document, is used as a basis for the protection of the symmetric key 424.

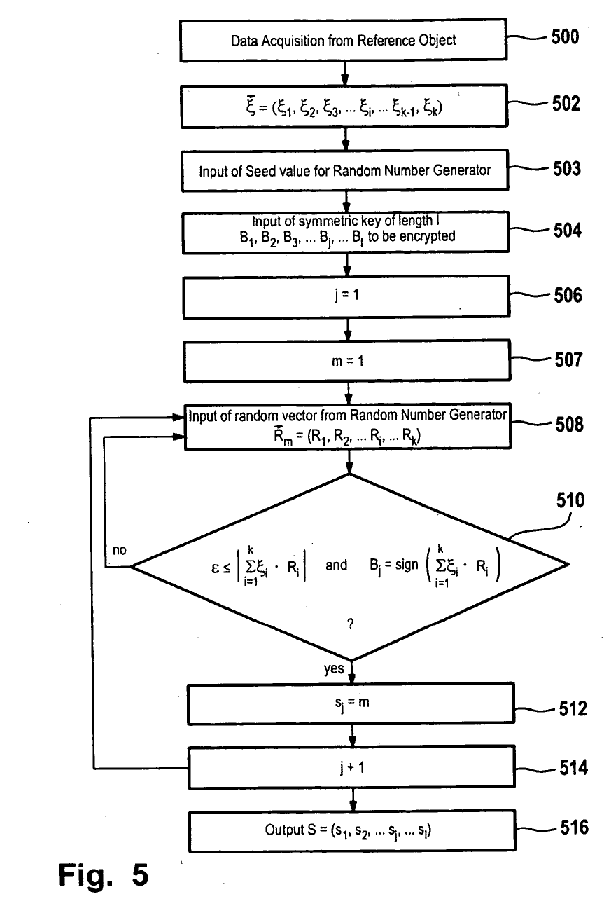

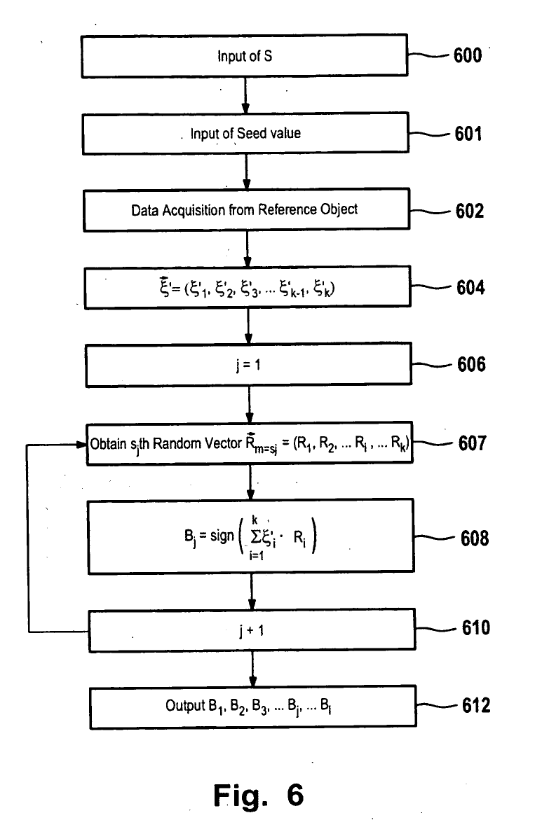

FIG. 5 shows a preferred embodiment of the encryption method of FIG. 1 that enables to compress the result of the encryption operation. Steps 500 and 502 are identical to steps 100 and 102 of FIG. 1. In step 503 a seed value for the pseudo random number generator is entered. In step 504 a symmetric key having a length l is entered. This corresponds to step 104 of FIG. 1. In addition to the initialisation of index j in step 506 (corresponds to step 106 of FIG. 1) index m is initialised in step 507. Index m is the running index of the random number generator.

In step 508 the first random vector Rₘ₌₁ of k random numbers Ri is generated by the pseudo random number generator on the basis of the seed value. This candidate random vector is evaluated in step 510 in the same way as in step 110 of FIG. 1. In case the candidate random vector \vec{R}ₘ₌₁ is accepted as it fulfils the conditions of step 510 only the running index m is stored in step 512 as an element of the sequence S that results from the encryption.

Step 514 corresponds to step 114. In step 516 the sequence S containing a number of 1 running indices is outputted rather than a matrix M having a number of 1×k random numbers. Hence, by storing the running indices and the seed value rather than the random vectors themselves a drastic compression of the result of the encoding operation is obtained.

FIG. 6 shows the corresponding decoding method that is similar to the decoding method of FIG. 3. In step 600 the sequence S is inputted. The seed value that was used for the encoding (cf. step 503 of FIG. 5) is inputted in step 601. Steps 602, 604, 606 are substantially identical to the corresponding steps 302, 304 and 306 of FIG. 3.

In step 607 a pseudo random generator that operates in accordance with the same algorithm as the pseudo random number generator that has been used for the encryption is used to recover the random vector \vec{R}ₘ₌ₛ_{ⱼ} based on the seed value entered in step 601. This way the random vector that is represented by the running index sj in the sequence S is recovered.

The following step 608 is identical to step 308 of FIG. 3. In step 610 the index j is incremented. From there the control returns to step 607 for recovery of the consecutive random vector having the running index sj. In step 612 the result of the decoding is outputted.

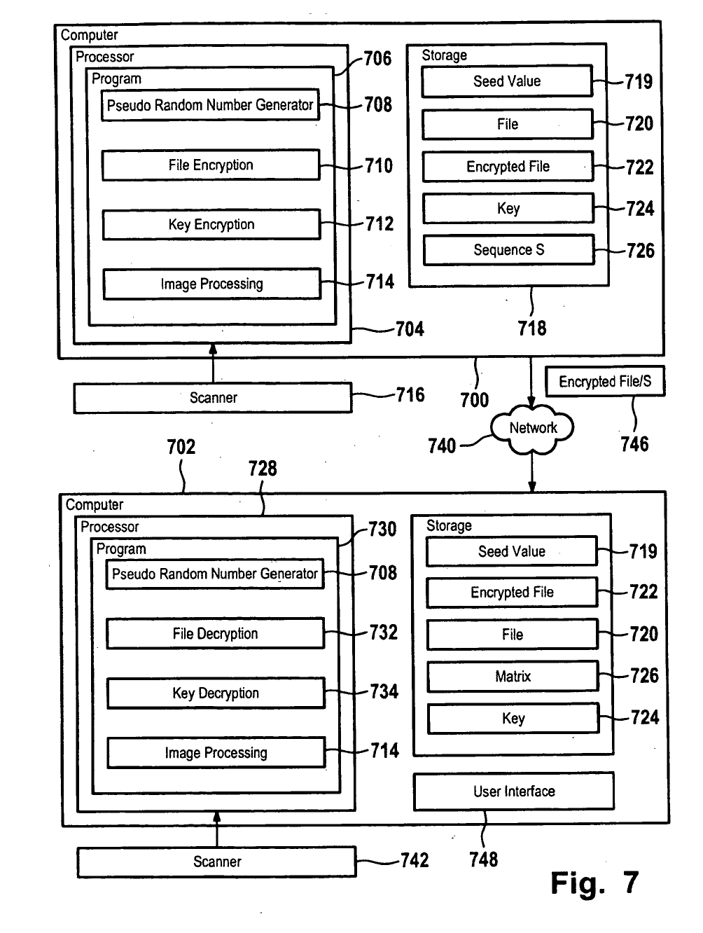

FIG. 7 shows a computer system that implements the methods of FIGS. 5 and 6. Elements of FIG. 7, that correspond to elements of FIG. 4 are designated by like reference numerals.

Program module 708 of program 706 implements a pseudo random number generator that produces a sequence of pseudo random numbers depending on an initial seed value. The seed value 719 is stored in storage 718. Computer 702 has user interface 748 for entering of seed value 719.

Program module 712 of program 706 implements the method of FIG. 5 whereas program module 734 of program 730 implements the decryption method of FIG. 6.

Operation of computer 700 for encryption of file 720 and symmetric key 724 is similar to operation of computer 400 of FIG. 4 except that seed value 719 is used as a basis for generation of pseudo random numbers by program module 708. The running indices of the accepted candidate random vectors are stored rather than the complete random vectors themselves which provides sequence S 726.

The encrypted file 722 and the sequence S 726 are transmitted as data object 746 from computer 700 to computer 702. The seed value can be memorised by the user and entered via user interface 748 into computer 702. Alternatively the seed value is transmitted from computer 700 to computer 702 as part of data object 746 for increased user convenience.

Operation of computer 702 is similar to operation of computer 402 of FIG. 4. Program 730 has program module 708 for generation of the pseudo random vectors as identified by sequence S 726 on the basis of see value 719. Program module 734 uses the recovered random vectors for performing the decryption of symmetric key 724.

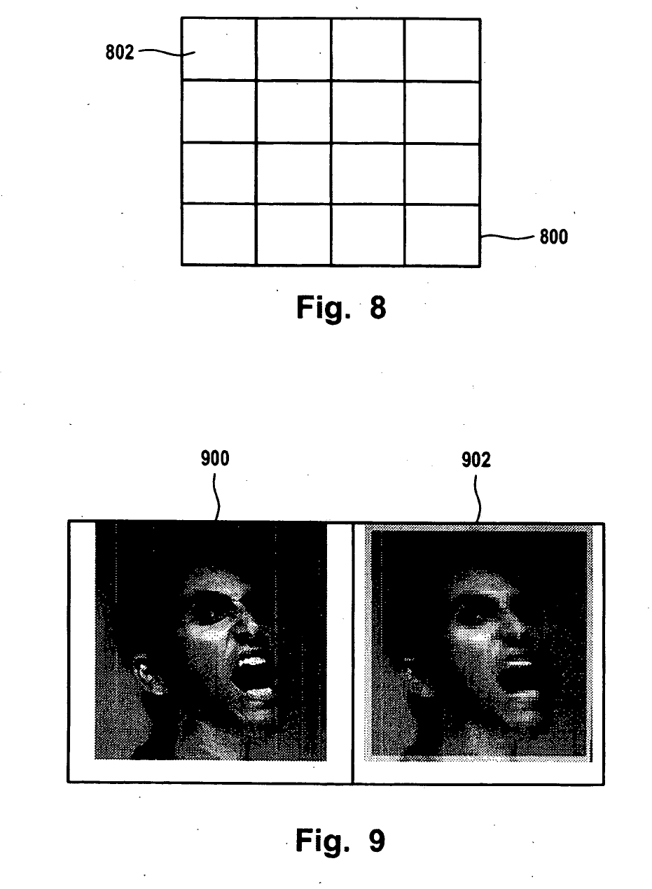

FIGS. 8 and 9 are illustrative of an example for data acquisition and a low pass filtering operation for the purpose of generating a reference data vector (cf. steps 100 and 110 of FIG. 1, steps 303 and 304 of FIG. 3, steps 500 and 502 of FIG. 5, and steps 602 and 604 of FIG. 6). FIG. 8 shows grid 800 that has grid elements 802. Grid 800 is used for filtering of an image. For each of the grid elements 802 a normalised average grey value is calculated. The normalised and averaged grey values provide the reference data vectors \vec{ξ} for encryption) and \vec{ξ}′ for decryption.

FIG. 9 shows original image 900 that is used as a reference object. By scanning of image 900 image data is obtained and low pass filtered by means of grid 800. The result of the filter operation is illustrated as image 902.

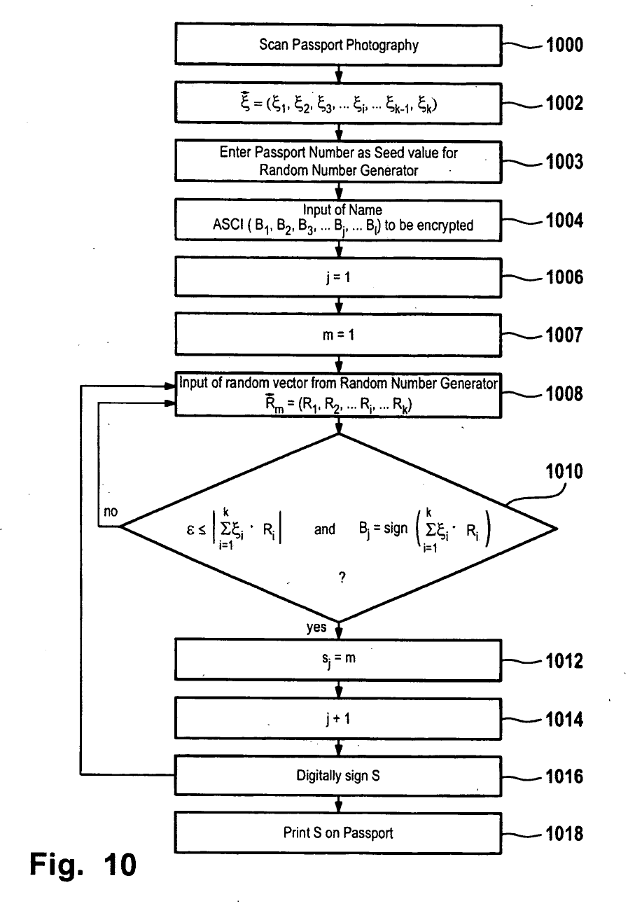

FIG. 10 illustrates an application example of the method of FIG. 5 for the purpose of producing a secure passport. For the purpose of data acquisition the passport photography is scanned in step 1000. On this basis the reference data vector is obtained in step 1002 (cf. corresponding steps 500 and 502 of FIG. 5). In step 1003 the passport number is entered as a seed value for the pseudo random number generator.

In step 1004 the name of the person for which the passport is produced is entered. The ASCI coded name is the information to be encrypted (cf. corresponding steps 503 and 504 of FIG. 5). The following steps 1006 to 1014 are substantially identical to the corresponding steps 506 to 514 of FIG. 5.

The resulting sequence S is digitally signed in step 1016 by the private key of the organisation that issues the passport. The digitally signed sequence S is printed on the passport in step 1018. This can be done by means of a bar code or otherwise. For example a digital circuit can be printed on the passport by means of a conductive polymer in order to store the digitally signed sequence S on the passport.

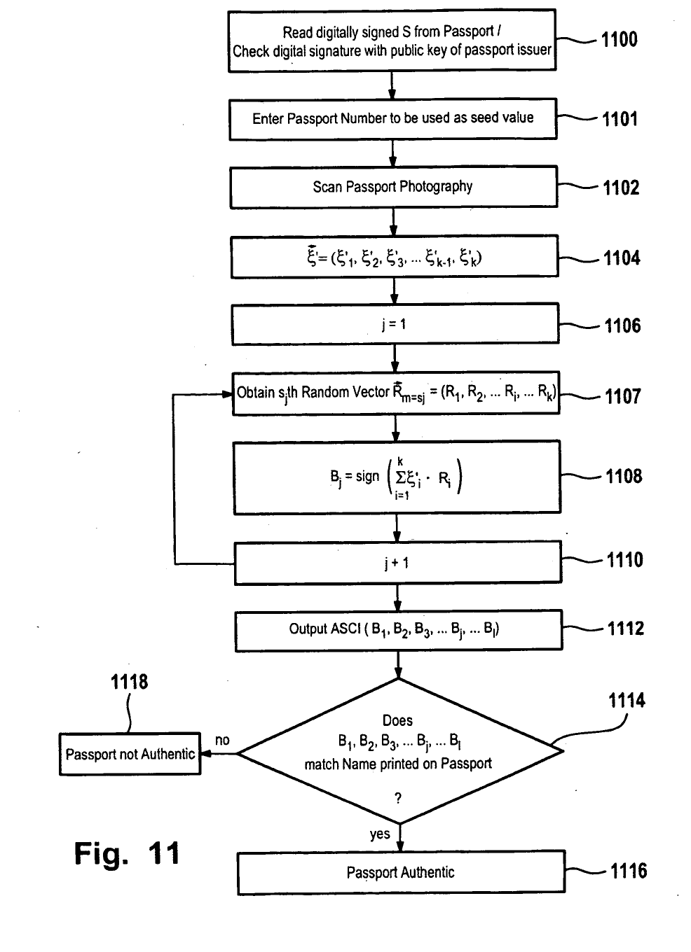

FIG. 11 shows a method for authenticating the passport that has been produced in accordance with the method of FIG. 10. This authentication method is an application of the decryption method of FIG. 6.

In step 1100 the digitally signed sequence S is read from the passport. By means of the public key of the issuer of the passport the digital signature is checked.

In step 1001 the passport number is entered as a seed value for the pseudo random number generator. In step 1002 the passport photography is scanned in order to obtain the reference data vectors \vec{ξ}′ (step 1104). The following steps 1106 to 1112 are identical to corresponding steps 606 to 612 of FIG. 6 whereby the ASCI and coded name is outputted in step 1112 as a result of the decoding operation. In step 1114 the name that is outputted in step 1112 is compared with the name that is printed on the passport. If the names match the passport is authentic (step 1116), otherwise the passport is not accepted and access may be refused (Step 1118).

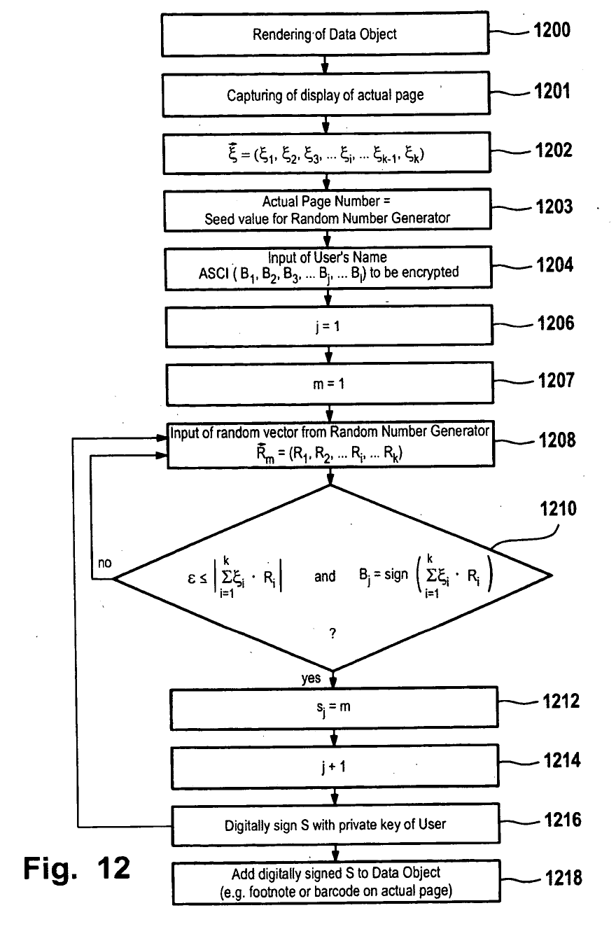

FIG. 12 illustrates another application example of the encoding method of FIG. 5. The method of FIG. 12 addresses a security problem of electronic commerce.

When a legal document is digitally signed by an authorised user the user relies on the correctness of the rendered display of the legal document. However the display may be filtered or manipulated otherwise such that it does not correspond to a normal rendering of the legal document.

For example the fonts of the computer have been manipulated to show digit ‘1’ instead of digit ‘6’. In this case the user risks to digitally sign e.g. a payment order in the amount of [symbol] 6,000,000 when his intention is only to authorise payment of [symbol] 1,000,000. In order to prevent such manipulations the rendered data object, e.g. a text file (step 1200), is captured in step 1201.

This can be done by means of a screen print operation that provides a copy of the content of the actual frame buffer. The image data that is obtained this way is filtered in order to provide the reference data vector (step 1202). The page number of the actual page is used as a seed value for the pseudo random number generator (step 1203). In step 1204 the user's name is entered. The ASCI coded user name is the information to be encrypted.

The following steps 1206 to 1214 are identical to the corresponding steps 506 to 514 of FIG. 5.

In step 1216 the resulting sequence S is digitally signed with the private key of the user. The digitally signed sequence S is added to the data object. In case the data object is a text file, such as a Word document, this can be done by adding the digitally signed sequence S to the footer or header of the file. Each page of the data object can be processed this way.

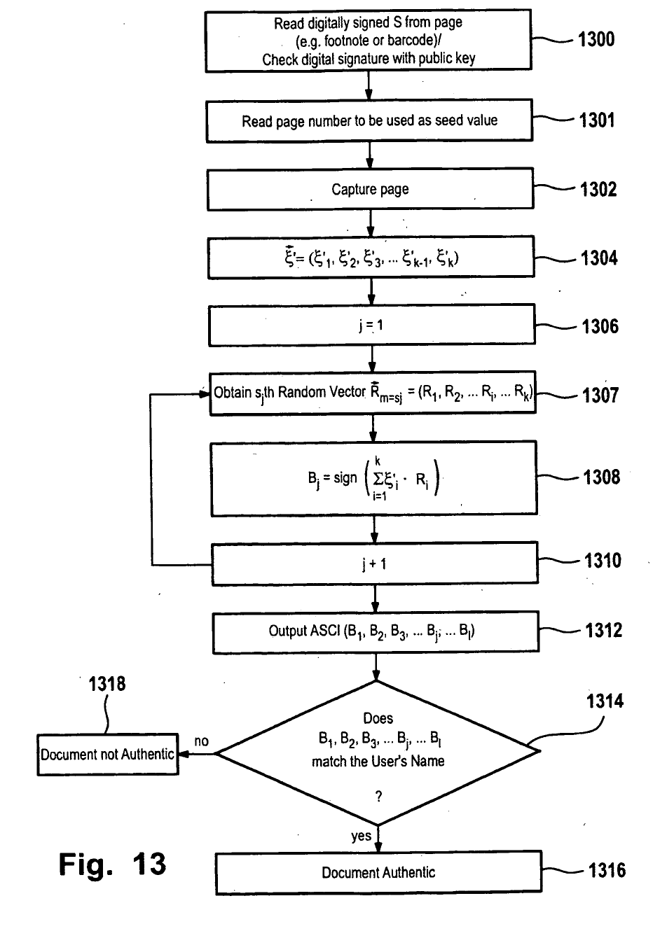

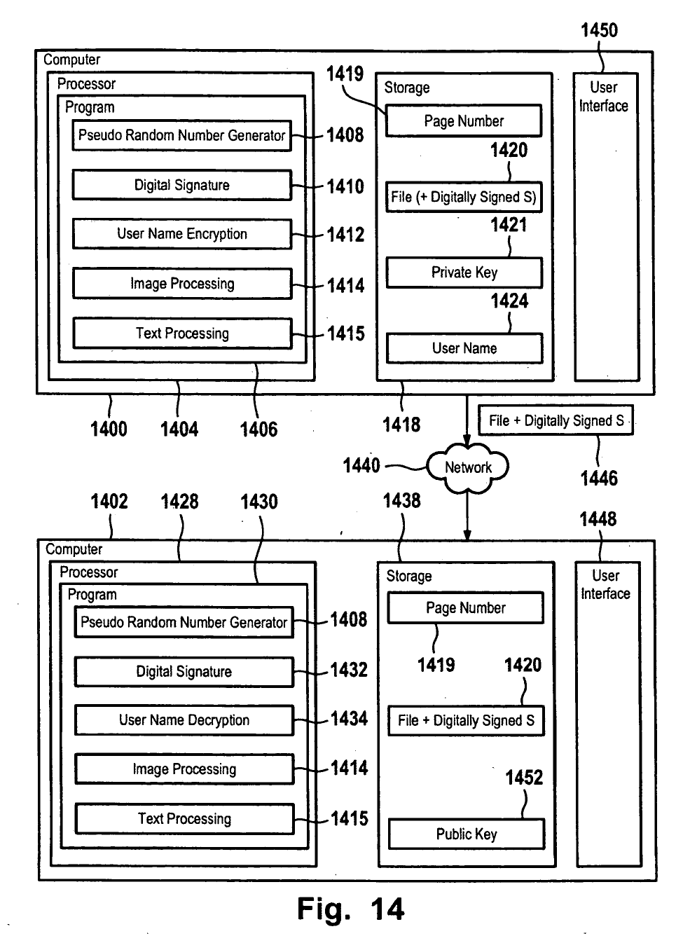

FIG. 13 shows the corresponding authentication method that is an application of the method of FIG. 6.

In step 1300 the digitally signed sequence S is read from the rendered data object. The digital signature is checked by means of the public key of the authorised user. In step 1301 the page number of the actual page is read and used as a seed value for the pseudo random number generator.

In step 1302 the actual page is captured by means of a screen print-type operation in order to provide image data. On the basis of the image data the reference data vector is obtained (step 1304). The following steps 1306 to 1318 are analogous to steps 1106 to 1118 of FIG. 11. If the user name that is obtained as a result of the decryption is correct the digital document is considered authentic (step 1116).

FIG. 14 shows a corresponding computer system that implements the methods of FIGS. 12 and 13.

Elements of the computer system of FIG. 14 that correspond to elements of the computer system of FIG. 7 are designated by like reference numerals.

Program 1406 has program module 1410 for digitally signing file 1420 by means of private key 1421 of an authorised user. Program module 1412 implements the method of FIG. 12 for encrypting the user's name 1424.

In operation file 1420 is rendered by text processing program module 1415, such as Microsoft Word. The actual page that is rendered by program module 1415 is captured by program module 1414 for image processing. The result of the image processing is a reference data vector that is provided to program module 1412 for encryption of user name 1424 in accordance with the method of FIG. 12. The result of the encryption, i.e. the sequence S, is digitally signed by means of program module 1410 using the user's private key 1421. The digitally signed sequence S is added to the file 1420.

For instance the page number of the page that is rendered by text processing program module 1415 is identified by image processing program module 1414 and stored as page number 1419 in storage 1418. This page number is used as a seed value for the pseudo random number generator implemented by program module 1408.

By means of user interface 1450 the authorised user can perform the corresponding user interactions. For example, the user may send file 1420 with the digitally signed sequence S to computer 1402 via network 1440. File 1420 is rendered by program module 1415. Further, the digitally signed sequence S and the page number 1419 are extracted from file 1420. Image processing program module 1414 uses the rendered file 1420 in order to provide the reference data vector

The digital signature of sequence S is checked by means of program module 1432. If it is correct the sequence S is decrypted by means of program module 1434 on the basis of the reference data vector using page number 1419 as a seed value for the pseudo random number generator implemented by program module 1408. As a result the name of the user is displayed on user interface 1448. If the displayed user name corresponds to the user of public key 1452 the rendered document is authentic.

### LIST OF REFERENCE NUMERALS

400 Computer
402 Computer
402 Processor
406 Program
408 Program Module
410 Program Module
412 Program Module.
414 Program Module
416 Scanner
418 Storage
420 File
422 Encrypted File
424 Symmetric Key
426 Matrix
428 Processor
430 Program
432 Program Module
434 Program Module
438 Storage
440 Network
442 Scanner
446 Data Object
700 Computer
702 Computer
704 Processor
706 Program
708 Program Module
710 Program Module
712 Program Module
714 Program Module
716 Scanner
718 Storage
719 Seed Value
720 File
722 Encrypted File
724 Symmetric Key
726 Sequence S
728 Processor
730 Program
732 Program Module
734 Program Module
738 Storage
740 Network
742 Scanner
746 Data Object
748 User Interface
800 Grid
802 Grid Elements
900 Image
902 Image
1400 Computer
1402 Computer
1404 Processor
1406 Program
1408 Program Module
1410 Program Module
1412 Program Module
1414 Program Module
1415 Program Module
1418 Storage
1419 Page Number
1420 File
1421 Private Key
1424 User Name
1428 Processor
1430 Program
1432 Program Module
1434 Program Module
1438 Storage
1440 Network
1446 Data Object
1448 User Interface
1450 User Interface
1452 Public Key

What is claimed is:

1. A method of encrypting binary data having a number of bits, the method comprising:
acquiring a reference data vector using a reference object; and
assigning a random vector for each one of the bits on the basis of the reference data vector.

2. The method of claim 1, the reference object being a physical object.

3. The method of claim 1, the reference object being a body portion.

4. The method of claim 1, the reference object being an utterance of a user.

5. The method of claim 1, wherein the acquisition of the reference data involves the acquisition of biometric data.

6. The method of claim 5, further comprising filtering of the biometric data in order to obtain the reference data.

7. The method of claim 6, wherein biometric features are extracted from the biometric data by means of the filtering and wherein the biometric features determine the reference data vector.

8. The method of claim 1, wherein an image is used as the reference object.

9. The method of claim 8, further comprising scanning the image in order to obtain image data and filtering of the image data to provide the reference data.

10. The method of claim 9, the filtering of the image data comprising a calculation of mean values of sub-sets of the image data.

11. The method of claim 10, the sub-sets of the image data being determined using a predefined grid.

12. The method of claim 1, the assignment of the random vector comprising:
a) generating a candidate random vector;
b) calculating the scalar product of the candidate random vector and the reference data vector;
c) if the absolute value of the scalar product is above a threshold value and the sign of the scalar product corresponds to the bit to be encoded, storing the candidate random vector for encoding of the bit; and
d) otherwise repeating steps a) to c).

13. The method of claim 12, wherein a pseudo random number generator is used for generating the candidate random vectors and wherein storage of the candidate random vector is performed by storage of its running index, and further comprising storing of a seed value of the pseudo random number generator.

14. The method of claim 1, wherein the binary data is representative of a data file.

15. The method of claim 1, wherein the binary data is representative of a user's personal data.

16. The method of claim 1, wherein the binary data is representative of a symmetric key.

17. A program for encrypting binary data having a number of bits stored on computer-readable medium, the program comprising logic configured to:
acquire a reference data vector using a reference object; and
assign a random vector for each one of the bits on the basis of the reference data vector.

18. An electronic system for encrypting binary data comprising:
means for acquiring a reference data vector using a reference object; and
means for assigning a random vector for each bit of a number of bits to be encoded on the basis of the reference data vector.

19. The electronic system of claim 18, the means for acquiring the reference data vector comprising a biometric data acquisition apparatus.

20. The electronic system of claim 18, the means for acquiring the reference data comprising an image data acquisition apparatus.

21. The electronic system of claim 18, further comprising means for rendering a data object, the means for acquiring the reference data vector being adapted to use the rendered data object as a reference object.

22. The electronic system of claim 18, the means for assigning the random vectors comprising processing means for performing the steps of:
a) generating a candidate random vector;
b) calculating the scalar product of the candidate random vector and the reference data vector;
c) if the absolute value of the scalar product is above a threshold value and the sign of the scalar product corresponds to the bit to be encoded, storing the candidate random vector for encoding of the bit; and
d) otherwise repeating steps a) to c).

23. The electronic system of claim 22, further comprising a pseudo random number generator for generating the candidate random vectors, wherein the processing means is adapted to perform the storage of the candidate random vectors by storage of the corresponding running indices and a seed value of the pseudo random number generator.

24. A method of decrypting binary data, the binary data comprising a set of random vectors, the method comprising:
acquiring a reference data vector from a reference object; and
decrypting one of the bits of the binary data on the basis of one of the random vectors and the reference data vector.

25. The method of claim 24, the random vectors being pseudo random, each random vector being represented by a running index, and further comprising entering a seed value for a pseudo random number generator in order to generate the random vectors on the basis of the seed value.

26. The method of claim 24, wherein the decryption of the one of the bits is performed by determining the sign of the scalar product of the one of the random vectors and the reference data vector.

27. A computer program for decrypting binary data stored on computer-readable medium, the program comprising logic configured to:
acquire a reference data vector from a reference object; and
decrypt one of the bits of the binary data on the basis of one of the random vectors and the reference data vector.

28. A logic circuit operable to decrypt binary data, comprising:
circuitry configured to acquire a reference data vector from a reference object; and
circuitry configured to decrypt one of the bits of the binary data on the basis of one of the random vectors and the reference data vector.

29. An electronic system for decrypting binary data, the binary data being encrypted by a set of random vectors, the electronic system comprising:
means for acquiring a reference data vector using a reference object; and
means for decrypting one of the bits of the binary data on the basis of the reference data vector and one of the random vectors of the set of random vectors.

30. The electronic system of claim 29, each one of the random vectors being represented by a running index, and further comprising a random number generator for generating the random vectors on the basis of a seed value.

31. The electronic system of claim 29, further comprising processing means for determining a sign of the scalar product of the one of the random vectors and the reference data vector.

32. An apparatus for encoding data comprising:
a data acquisition component for acquisition of reference data using a reference object; and
a data processing component for determining a set of random numbers for each data bit to be encoded on the basis of the reference data.

33. An apparatus for decoding a set of random numbers comprising:
a data acquisition component for acquisition of reference data from a reference object; and
a data processing component for decoding of one of the bits of the data on the basis of the reference data and of the encoded data.

34. A data carrier for data that is encoded in accordance with acquiring a reference data vector using a reference object, and that is encoded in accordance with assigning a random vector for each one of the bits on the basis of the reference data vector.

35. The data carrier of claim 34, the data carrier being at least one of a printed document or a chip card.

36. A logic circuit operable to carry out a method in accordance with acquiring a reference data vector using a reference object, and that is encoded in accordance with assigning a random vector for each one of the bits on the basis of the reference data vector.
